(19) United States
(12) Patent Application Publication
(10) Pub. No.: US 2007/0002695 A1
(43) Pub. Date: Jan. 4, 2007

(54) Optical information recording medium and optical information recording/reproducing apparatus

(76) Inventors: Eiji Kariyada, Tokyo (JP); Shuichi Ohkubo, Tokyo (JP); Hideki Tanabe, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 10/570,493

(22) PCT Filed: Jul. 15, 2004
(86) PCT No.: PCT/JP04/10135

§ 371 Date: Mar. 3, 2006

(30) Foreign Application Priority Data
Sep. 5, 2003 (JP) 2003-314392

(51) Int. Cl. G11B 7/085

(52) U.S. Cl. 369/30.03

(57) ABSTRACT

An optical information recording medium, in which a first dielectric layer (2), a recording layer (3), a second dielectric layer (4), and a reflective layer (5) are sequentially formed in this order on a transparent resin substrate (1). The recording layer (3) comprises fine crystal grains (7) dispersed in a matrix (6) composed of a dielectric such as SiO₂. The recording layer (3) has a thickness of 7 to 15 nm, and the fine crystal grains (7) have a particle diameter of 3 to 7 nm. The fine crystal grains (7) are made of an Ag—Pd—Cu alloy composed of 0.3 to 25 mass % of Pd and 0.3 to 25 mass % of Cu, the balance being Ag and unavoidable impurities. Information is recorded or reproduced by irradiating a blue-violet semiconductor laser having a wavelength of 380 to 430 nm to this optical information recording medium.

### TECHNICAL FIELD

The present invention relates to an optical information recording medium on which information is recorded and from which information is reproduced by irradiating a laser beam, and an optical information recording/reproducing apparatus for recording and reproducing information to and from this optical information recording medium.

### BACKGROUND ART

With the rapid propagation of CD-ROM (Compact Disk Read Only Memory) and DVD-ROM (Digital Versatile Disc—ROM), “write once” optical information recording media (hereinafter referred to as “optical recording media”, or simply “media”) such as CD-R (Compact Disc Recordable) and DVD-R (Digital Versatile Disc Recordable), on which users can write data only once, have recently been increasingly widespread. In the above mentioned CD-R and DVD-R, a photosensitive dye layer is formed as a recording layer on a substrate by a spin coating or deposition method. To achieve a reflectance equal to that of CD-ROM and the like, a reflective layer made of metal such as Al or Au is formed on the dye layer. The semiconductor laser beam used for the recording and reproduction of information has a wavelength of about 780 nm for CD-R, and about 650 nm for DVD-R. The dye material being used is selected so that light absorption is high enough for the recording with the semiconductor laser beam having these wavelengths.

Meanwhile, research and development of blue-violet semiconductor laser has recently progressed rapidly, and semiconductor laser with a wavelength of 380 to 430 nm will soon begin to be used. The recording density of optical recording media primarily depends on the focus spot size of light beam used for the recording and reproduction of information. As the focus spot size is proportional to the wavelength of light beam, it will become smaller if a blue-violet semiconductor laser beam with a shorter wavelength is used rather than the red semiconductor laser that is currently being used, whereby the recording capacity of optical recording media is expected to increase largely.

Apart from the method that uses the above described photosensitive dye layer, there has been proposed another optical recording medium that uses such a blue-violet semiconductor laser beam, wherein the recording layer is a super-thin insular metal film that is formed of fine dispersed particles of metal such as Au, Ag, or Cu, the thin film being formed on a spacer layer made of transparent organic resin. The super-thin insular metal film can be obtained by a deposition or a sputtering method in which the metal film deposition is stopped at an initial stage. With this optical recording medium, marks are formed by bubble-forming of transparent resin or mutual diffusion of two types of metal, triggered by laser irradiation (see, for example, Patent Document 1: Japanese Patent Laid-Open No. 2002-11957, and Non-Patent Document 1: Extended Abstracts, The 50th Meeting of Japan Society of Applied Physics and Related Societies, 27p-ZW-4).

In another optical recording medium that has been proposed so far, a thin film of metal, semiconductor, or the like is formed as a recording layer on a PC (polycarbonate) substrate, and laser is irradiated to heat this thin film and to cause deformation of the thin film and the substrate in the heated portion, so that information is recorded.

[Patent Document 1]: Japanese Patent Laid-Open Publication No. 2002-11957

[Non-Patent Document 1]: Extended Abstracts, The 50th Meeting of Japan Society of Applied Physics and Related Societies, 27p-ZW-4.

### DISCLOSURE OF THE INVENTION

### Problems to be Solved by the Invention

The above described conventional techniques, however, had the following drawbacks: First, as for the optical recording medium that uses a dye layer as the recording layer, the dye material suitable for a blue-violet semiconductor laser beam having a wavelength of 380 to 430 nm is still being developed and a material that can actually be used is yet to be developed. More specifically, after information is recorded by forming a mark in the dye layer, when a reproducing laser beam is irradiated to this mark for a certain length of time, the recorded information will eventually be deteriorated. Another drawback is that the production process of the optical recording medium with a dye layer is complex because it requires another sputtering process step or the like to form a reflective layer after the dye material has been coated on the substrate by spin coating. A further drawback is that in a medium with a dye recording layer, light transmission of the recording layer is low, and such a structure is not suitable for the production of optical information recording medium having two or more recording layers for multilayer recording.

In an optical recording medium wherein the recording layer is a super-thin insular metal film made of fine dispersed particles of metal such as Au, Ag, or Cu and this insular metal film is interposed between organic resin films, the recording layer has a dispersed particle structure in which metal particles with a diameter ranging from a few nanometers to several tens nanometers are distributed two-dimensionally. The amount of metal particles is therefore very small, and when the disk is rotated at high speed during information recording, the recording laser power becomes insufficient, because of which a recording mark with a high signal quality is hard to form. Also, because of the dispersed particle structure with two-dimensionally distributed metal particles, noise is high during reproduction. Further, the film thickness of the insular metal film is hard to control because it must be limited to a very small range of about 10 nm or lower. Furthermore, because the organic resin films are formed by spin coating, the production process is complex.

As for the optical recording medium on which information is recorded by deformation of the thin film and substrate triggered by laser irradiation, a noise increase is distinct because of the substrate deformation during recording, and a low-noise reproducing signal is hard to achieve. When the groove pitch is reduced for higher density, in particular, or in land/groove recording wherein information is recorded on both of the grooves of the substrate and flat lands between the grooves, the influence of substrate deformation during recording extends to adjacent recording areas, and high density recording is hard to achieve.

The present invention was devised in view of these problems, and an object of the invention is to provide an optical information recording medium which is easily producible and achieves high quality of reproducing signal even with the use of a blue-violet semiconductor laser beam for the recording and reproduction and which is capable of multilayer recording, and an optical information recording/reproducing apparatus for recording information on this optical information recording medium and for reproducing the information.

### MEANS FOR SOLVING THE PROBLEMS

An optical information recording medium according to the present invention includes a substrate and a recording layer formed on the substrate, information being recorded and reproduced by irradiating light to this recording layer, and is characterized in that the recording layer includes a matrix made of a dielectric and a plurality of fine crystal grains made of a metal or an alloy and dispersed in the matrix, and, by irradiating light to the recording layer, a size of the fine crystal grains is changed in a portion irradiated by the light, whereby information is recorded.

According to the invention, by irradiating light to the recording layer, the size of the fine crystal grains is changed in the irradiated portion of the recording layer, and the reflectance in this irradiated portion changes. Thereby, a mark is formed in the irradiated portion of the recording layer, and information is recorded. This optical information recording medium is easily producible because there is no need of forming an organic resin film by means of spin coating or the like.

Preferably, the fine crystal grains should be made of a metal or an alloy of two or more metals selected from the group consisting of Ag, Cu, In, Pd, and Te. The fine crystal grains should preferably be made of an Ag—Pd—Cu alloy containing 0.3 to 25 mass % of Pd and 0.3 to 25 mass % of Cu, the balance being Ag and unavoidable impurities, or an Ag—Te alloy containing 38 to 55 mass % of Te, the balance being Ag and unavoidable impurities, or a Cu—In alloy containing 40 to 95 mass % of In, the balance being Cu and unavoidable impurities. Thereby, good recording/reproducing characteristics and good corrosion resistance are both achieved.

Furthermore, the recording layer may consist of a plurality of layers, which are separated from each other by an interlayer optical separation layer. Thereby, information is recorded in each of the plurality of layers, and the recording density of the optical information recording medium is increased.

Further, the light should preferably be a laser beam with a wavelength of 380 to 430 nm. Thereby, a small spot can be formed on the recording layer and the recording density can be increased.

An optical information recording/reproducing apparatus according to the present invention is characterized in that light is irradiated to the above described optical information recording medium to change the size of the fine crystal grains in a portion of the recording layer irradiated by the light and to change the reflectance of this portion so that information is recorded, and the information is reproduced by detecting a difference in the reflectance of the recording layer.

### ADVANTAGE OF THE INVENTION

According to this invention, the size of the fine crystal grains of the recording layer is changed by irradiating light so that information is recorded. Thus an optical information recording medium that is easily producible and achieves high quality of reproducing signal even with the use of a blue-violet semiconductor laser beam for the recording and reproduction is realized.

### BRIEF DESCRIPTION OF THE DRAWINGS

FIG. 1 is a cross-sectional view illustrating a first embodiment of the optical information recording medium of the invention;

FIG. 2 is a cross-sectional view illustrating a second embodiment of the optical information recording medium of the invention;

FIG. 3 is a cross-sectional view illustrating a third embodiment of the optical information recording medium of the invention;

FIG. 4 is a block diagram illustrating a fifth embodiment of the optical information recording/reproducing apparatus of the invention; and

FIG. 5 is a graph showing the influence of linear speed on the quality of reproduction signal, the horizontal axis representing the linear speed of the optical disk medium during recording and reproduction and the vertical axis representing the C/N ratio of 8T signal.

### DESCRIPTION OF REFERENCE NUMERALS

1 Transparent resin substrate;
2, 2a First dielectric layer;
2b Third dielectric layer;
3 Recording layer;
3a First recording layer;
3b Second recording layer;
4, 4a Second dielectric layer;
4b Fourth dielectric layer;
5 Reflective layer;
6 Matrix;
7 Fine crystal grains;
8 Optical separation layer;
9 Dummy transparent resin substrate;
100 Disk;
101 Spindle motor;
102 Rotation control circuit;
103 Servo control circuit;
104 Optical head;
105 Recording/reproducing circuit;
106 Wobble detection circuit;
107 Address detection circuit;
108 Recorded data processing circuit;
109 Synchronizing signal generation circuit;
110 Reproduced data processing circuit;
111 Interface;
112 Controller

### BEST MODE FOR CARRYING OUT THE INVENTION

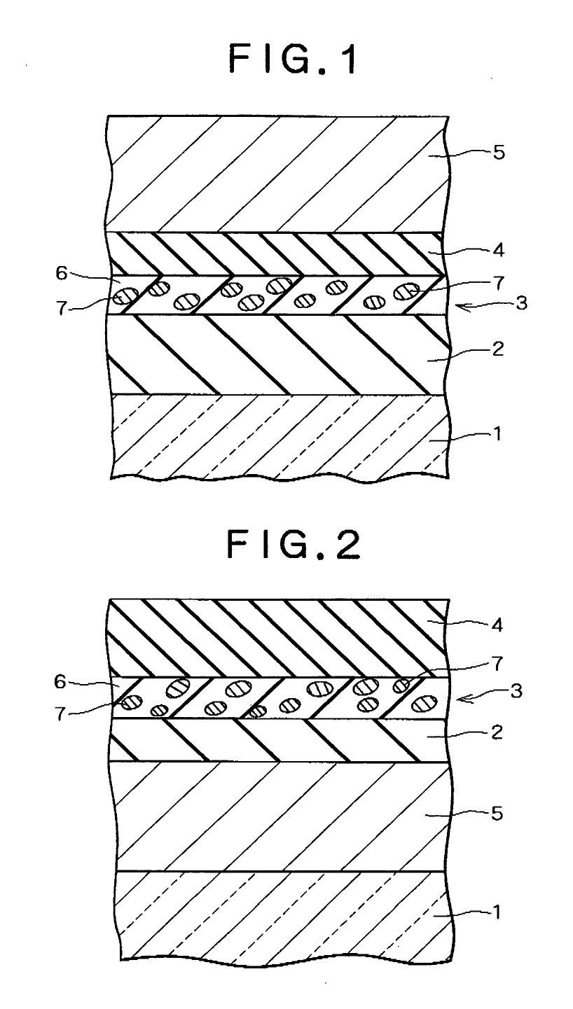

Specific embodiments of the present invention will be hereinafter described with reference to the accompanying drawings. A first embodiment of the invention will be described first. FIG. 1 is a cross-sectional view illustrating the optical information recording medium according to the present embodiment. In this specification, the scale in vertical and horizontal directions and the aspect ratio of the drawings are discretionary.

As shown in FIG. 1, the optical recording medium according to the present embodiment includes a disk-like transparent resin substrate 1. The transparent resin substrate 1 has a diameter of, for example, 120 mm, and a thickness of, for example, 0.6 mm, and is formed with guide grooves or pre-pits (not shown) on the surface. A first dielectric layer 2, a recording layer 3, a second dielectric layer 4, and a reflective layer 5 are sequentially formed in this order on the transparent resin substrate 1. On the reflective layer 5 is formed a UV curable resin layer (not shown), on which a 0.6 mm thick dummy transparent resin substrate is bonded (not shown). The transparent resin substrate 1 and the dummy transparent resin substrate are, for example, PC substrates. The first dielectric layer 2 and the second dielectric layer 4 are made of, for example, ZnS—SiO₂. The reflective layer 5 is made of, for example, an AlTi alloy.

The recording layer 3 contains fine crystal grains 7 of metal or alloy dispersed in a dielectric matrix 6. The dielectric forming the matrix 6 is, for example, an oxide dielectric, such as silicon oxide (SiO₂). The fine crystal grains 7 are made of a metal or an alloy of two or more metals selected from the group consisting of, for example, silver (Ag), copper (Cu), indium (In), palladium (Pd), and tellurium (Te); it is, for example, an Ag—Pd—Cu alloy containing 0.3 to 25 mass % of Pd and 0.3 to 25 mass % of Cu, the balance being Ag and unavoidable impurities. The recording layer 3 has a thickness of, for example, 5 to 25 nm, more specifically 7 to 15 nm, and is a polycrystalline layer. The recording layer 3 contains fine crystal grains 7 at a rate of, for example, 30 to 80 volume %. The fine crystal grains 7 should preferably have a particle diameter of not more than 10 nm, and more specifically 3 to 7 nm.

The dielectric forming the matrix 6 is not limited to silicon oxide (SiO₂) and may be, for example, aluminum oxide (Al₂O₃) or tantalum oxide (Ta₂O₅). Alternatively, the dielectric forming the matrix 6 may be a nitride dielectric, such as silicon nitride (SiN), aluminum nitride (AlN), or tantalum nitride (TaN). Or it may be a mixture or a compound of two or more of the above listed oxides and/or nitrides.

The metal or alloy forming the fine crystal grains 7 is not limited to the Ag—Pd—Cu alloy, and may be, for example, an Ag—Te alloy containing 38 to 55 mass % of Te, the balance being Ag and unavoidable impurities, or a Cu—In alloy containing 40 to 95 mass % of In, the balance being Cu and unavoidable impurities. In these cases, too, the content and particle diameter of the fine crystal grains 7 should preferably be within the above noted ranges.

The followings are the reasons for the numerical limitations on various constituent elements of the present invention.

Thickness of Recording Layer: 5 to 25 nm

If the thickness of the recording layer is less than 5 nm, the light transmission will be high and light absorption will be low in the recording layer, which makes it hard to record information. On the other hand, if the thickness of the recording layer exceeds 25 nm, then the reflectance of the recording layer will be too high, which will lower the light absorption, making it hard to record information. Therefore, the recording layer should preferably have a thickness of 5 to 25 nm. More preferably, it may be 7 to 15 nm.

Contents of Pd and Cu when the Fine Crystal Grains are Made of an Ag—Pd—Cu Alloy: 0.3 to 25 mass %

Ag itself has low corrosion resistance to sulfur and chloride components. Pd on the other hand is stable relative to sulfur and chloride. Therefore, adding Pd to Ag in a range of 0.1 to 30.0 mass % increases the corrosion resistance. Note, an alloy consisting only of Ag and Pd has low corrosion resistance in a high temperature, high moisture atmosphere, and an Ag—Pd alloy medium may corrode if it is left in such an environment. However, adding Cu to the Ag—Pd alloy in a range of 0.1 to 30.0 mass % increases the corrosion resistance in a high temperature, high moisture atmosphere. In the above noted ranges of composition, if Pb content is 0.3 to 25 mass % and Cu content is 0.3 to 25 mass %, the recording/reproducing characteristics are particularly favorable. Therefore, the contents of Pd and Cu in the Ag—Pd—Cu alloy should preferably be 0.3 to 25 mass %, respectively.

Content of Te when the Fine Crystal Grains are Made of an Ag—Te Alloy: 38 to 55 mass %

As mentioned above, while Ag itself has low corrosion resistance to sulfur and chloride contents, if Te is added in an amount of 33 mass % or more, its corrosion resistance to sulfur and chloride contents is improved. Meanwhile, as the Te content in the Ag—Te alloy is increased, the melting point of the Ag—Te alloy is lowered. If the melting point of the Ag—Te alloy is too high, a high laser power is required to record information, and if the melting point of the Ag—Te alloy is too low, the storage stability of recorded information may be deteriorated. If an Ag—Te alloy is to be used for forming the above noted fine crystal grains of the recording layer, the melting point of the Ag—Te alloy should preferably be in a range of 400 to 700° C. The corresponding range of the mixture rate of Te is 38 to 55 mass %. Therefore, the Te content in the Ag—Te alloy should preferably be in a range of 38 to 55 mass %.

Content of In when the Fine Crystal Grains are Made of an Cu—In Alloy: 40 to 95 mass % Cu itself has a melting point of about 1083° C., and if the fine crystal grains are made of Cu alone, then an extremely high laser power is necessary to record information by laser irradiation. Therefore, it is preferable to add In having a lower melting point to Cu and to form the fine crystal grains from a Cu—In alloy that has a lower melting point than Cu alone. As mentioned above, the material forming the fine crystal grains should preferably have a melting point of about 400 to 700° C.; adding In in an amount of 40 to 95 mass % makes the melting point of the Cu—In alloy to be in this temperature range. The reproducing characteristics are also favorable, when the fine crystal grains are made of a Cu—In alloy with this range of composition. Therefore, the In content in the Cu—In alloy should preferably be in a range of 40 to 95 mass %.

Next, the method of producing this embodiment of the optical recording medium will be described. Using an inline sputtering machine, each of the layers described below is formed sequentially on the transparent resin substrate 1, on which laser-guiding grooves or pre-pits (not shown) have been formed beforehand. A ZnS—SiO₂ film is first deposited by sputtering to form the first dielectric layer 2. Next, co-sputtering is performed using two targets at the same time, one being SiO₂ and the other being Al—Cu—Pd alloy, for example. This forms the recording layer 3, consisting of a matrix 6 of SiO₂ and fine crystal grains 7 of Al—Cu—Pd alloy dispersed in the matrix. Next, a ZnS—SiO₂ film is deposited by sputtering to form the second dielectric layer 4. Next, an Al—Ti alloy film is deposited by sputtering to form the reflective layer 5. Then, the dummy transparent resin substrate is stacked on the reflective layer 5 via a UV curable resin layer, and UV light is irradiated to cure the UV curable resin layer to bond the dummy transparent resin substrate on the reflective layer 5. The optical recording medium according to the present embodiment is thus produced.

Next, a description will be given on the operation of the optical recording medium according to the present embodiment structured as described above. When recording information on this optical recording medium, a blue-violet semiconductor laser beam having a wavelength of, for example, 380 to 430 nm is made incident from the side of the transparent resin substrate 1, as a recording laser beam. The recording laser beam is passed through the transparent resin substrate 1 and the first dielectric layer 2, and irradiated to the recording layer 3. The laser beam that has passed through the recording layer 3 further passes through the second dielectric layer 4, is reflected by the reflective layer 5, passes through the second dielectric layer 4 again, and is irradiated to the recording layer 3. This heats up the laser-irradiated portion of the recording layer 3, melting the fine crystal grains 7 in this portion and making adjacent fine crystal grains 7 to cohere, as a result of which the particle diameter of the fine crystal grains 7 becomes larger than that before the laser irradiation. With the change in the particle diameter, the optical constants of the laser-irradiated portion of the recording layer 3, such as the index of refraction and extinction coefficient, change, and the reflectance is lowered. For example, the reflectance of the recording layer 3, which is 20% before the laser irradiation, reduces to 7% by the laser irradiation. Thus, the laser-irradiated portion of the recording layer 3 is formed with a mark having lower light reflectance than the surroundings, whereby information is recorded.

When reproducing the recorded information, a reproducing laser beam having a lower intensity than the above mentioned recording laser beam is made incident from the side of the transparent resin substrate 1. The reproducing laser beam may have, for example, the same wavelength as that of the recording laser beam. The reproducing laser beam passes through the transparent resin substrate 1 and the first dielectric layer 2, is irradiated to the recording layer 3, reflected by the recording layer 3, passes through the first dielectric layer 2 and the transparent resin substrate 1 again, and is output to the outside of the optical recording medium. The laser beam that has passed through the recording layer 3 passes through the second dielectric layer 4, is reflected by the reflective layer 5, passes through the second dielectric layer 4, the recording layer 3, the first dielectric layer 2, and the transparent resin substrate 1 again, and is output to the outside. Since the light reflectance is different in the mark (recorded portion) from that in other parts (non-recorded portions) in the recording layer 3, there is a difference in the amount of feedback light (reflected light amount) between the mark and other parts. By detecting the difference in the light amount, information recorded in the recording layer 3 can be read out.

According to the present embodiment, as described above, since information is recorded by changing the particle diameter of the fine crystal grains through fusion and cohesion triggered by laser irradiation, the quality of reproducing signal is high even with the use of a blue-violet semiconductor laser beam. Also, because the recording layer does not contain a dye, the mark (recorded portion) does not deteriorate. Further, since there is no deformation of the PC substrate in the laser-irradiated portion at the time of recording, there is no increase in noise at the time of reproduction. Furthermore, while, in the optical recording medium described in the above mentioned Patent Document 1 and Non-Patent Document 1, marks are formed by creating a disturbance in particle distribution by bubble-forming of the transparent resin layer, in the present embodiment, marks are formed by changing the size and shape of the fine crystal grains through fusion and cohesion. Therefore, as compared to the techniques described in the above mentioned Patent Document 1 and Non-Patent Document 1, the difference in the reflectance between the mark portion and non-mark portion is large, and the quality of the reproducing signal is high in the present embodiment. Accordingly, the optical recording medium according to the present embodiment is also suitable for high density recording/reproduction such as land/groove recording.

Furthermore, since the layers can be sequentially formed using only a sputtering method from the first dielectric layer 2 to the reflective layer 5 and there is no need to form a resin layer in the middle step by a spin coating method or the like, the manufacturing process is simple and production is easy. Also, since there is no need to deposit a super-thin layer, the production conditions are readily controlled. Moreover, since the recording layer is formed by co-sputtering using an alloy target and a dielectric target, a polycrystalline film is formed in which fine crystal grains are uniformly dispersed in the matrix. As a result, an optical recording medium, for which a blue-violet semiconductor laser beam can be used, which achieves high quality of reproducing signal, and which is readily producible, is realized.

Next, a second embodiment of the present invention is described. FIG. 2 is a cross-sectional view illustrating the optical information recording medium according to the present embodiment. As shown in FIG. 2, the optical recording medium according to the present embodiment includes a disk-like transparent resin substrate 1, which has a diameter of, for example, 120 mm, and a thickness of, for example, 1.2 mm. A reflective layer 5, a first dielectric layer 2, a recording layer 3, and a second dielectric layer 4, are sequentially formed in this order from the substrate side on the transparent resin substrate 1. On the second dielectric layer 4 is formed a UV curable resin layer (not shown), on which a 100 μm thick transparent PC film is bonded (not shown) to form a PC cover layer. The recording layer 3 contains fine crystal grains 7 of metal or alloy dispersed in a dielectric matrix 6. The dielectric forming the matrix 6 is, for example, an oxide dielectric, such as silicon oxide (SiO₂). The fine crystal grains 7 are made of a metal or an alloy of two or more metals selected from the group consisting of, for example, silver (Ag), copper (Cu), indium (In), palladium (Pd), and tellurium (Te); it is, for example, an Ag—Pd—Cu alloy containing 0.3 to 25 mass % of Pd and 0.3 to 25 mass % of Cu, the balance being Ag and unavoidable impurities. The features of this embodiment other than those described above are the same as those of the first embodiment described in the foregoing.

Next, the method of producing the optical recording medium according to the present embodiment will be described. An Al—Ti alloy film is deposited, for example, by a sputtering method on the transparent resin substrate 1 to form the reflective layer 5. Next, a ZnS—SiO₂ film is deposited by a sputtering method to form the first dielectric layer 2. Then, again by a sputtering method, co-sputtering is performed using two targets at the same time, one being SiO₂ and the other being Al—Cu—Pd alloy, for example. This forms the recording layer 3, comprising a matrix 6 of SiO₂ and fine crystal grains 7 of Al—Cu—Pd alloy dispersed in the matrix. Next, a ZnS—SiO₂ film is deposited by a sputtering method to form the second dielectric layer 4. Then, through a UV curable resin layer, the transparent PC film is bonded on the second dielectric layer 4 as a light transmission layer to form the PC cover layer. The optical recording medium according to the present embodiment is thus produced. With the optical recording medium according to the present embodiment, the recording laser beam and the reproducing laser beam are made incident from the side of the PC film. The operation and effects of the present embodiment are the same as those of the first embodiment described in the foregoing.

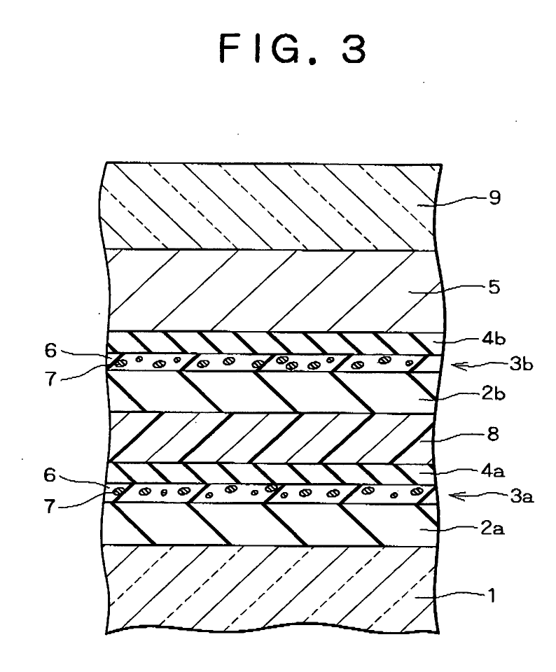

Next, a third embodiment of the present invention is described. FIG. 3 is a cross-sectional view illustrating the optical information recording medium according to the present embodiment. As shown in FIG. 3, the optical recording medium according to the present embodiment includes a double-layer recording layer. That is, the medium includes a disk-like transparent resin substrate 1, which has a diameter of, for example, 120 mm, and a thickness of, for example, 0.6 mm, and on this transparent resin substrate 1, a first dielectric layer 2a, a first recording layer 3a, a second dielectric layer 4a, an optical separation layer 8, a third dielectric layer 2b, a second recording layer 3b, a fourth dielectric layer 4b, a reflective layer 5, a UV curable resin layer (not shown), and a dummy transparent resin substrate 9 are sequentially formed in this order from the side of the substrate 1. The first recording layer 3a has a thickness of, for example, 7 nm, and the second recording layer 3b has a thickness of, for example, 12 nm. The first and second recording layers 3a and 3b contain fine crystal grains 7 dispersed in a matrix 6. The optical separation layer 8 is made, for example, of a UV curable resin. With the optical recording medium according to the present embodiment, the recording laser beam and the reproducing laser beam are made incident from the side of the transparent resin substrate 1. The features other than those described above, production method and operation of the present embodiment are the same as those of the first embodiment described in the foregoing.

In the present embodiment, since the recording layer does not contain any dye material, the recording layer has high light transmission, and can have the double-layer structure. Thereby, the recording density can be made twice higher than that of an optical recording medium having a single-layer recording layer. The effects of the present embodiment other than the above are the same as those of the first embodiment described in the foregoing.

Next, a fourth embodiment of the present invention is described. The optical recording medium according to the present embodiment includes a transparent resin substrate having a thickness of, for example, 1.2 mm, and a reflective layer, a dielectric layer, a second recording layer, a dielectric layer, an optical separation layer, a dielectric layer, a first recording layer, a dielectric layer, a UV curable resin layer, and a PC cover layer are sequentially formed in this order on the transparent resin substrate. With this optical recording medium, the recording laser beam and the reproducing laser beam are made incident from the side of the PC cover layer. The features other than those described above, operation and effects of the present embodiment are the same as those of the third embodiment described in the foregoing.

While the recording layer of the third and fourth embodiments described above has a double-layer structure, it may have three or more layers. Thereby, the recording density can further be increased.

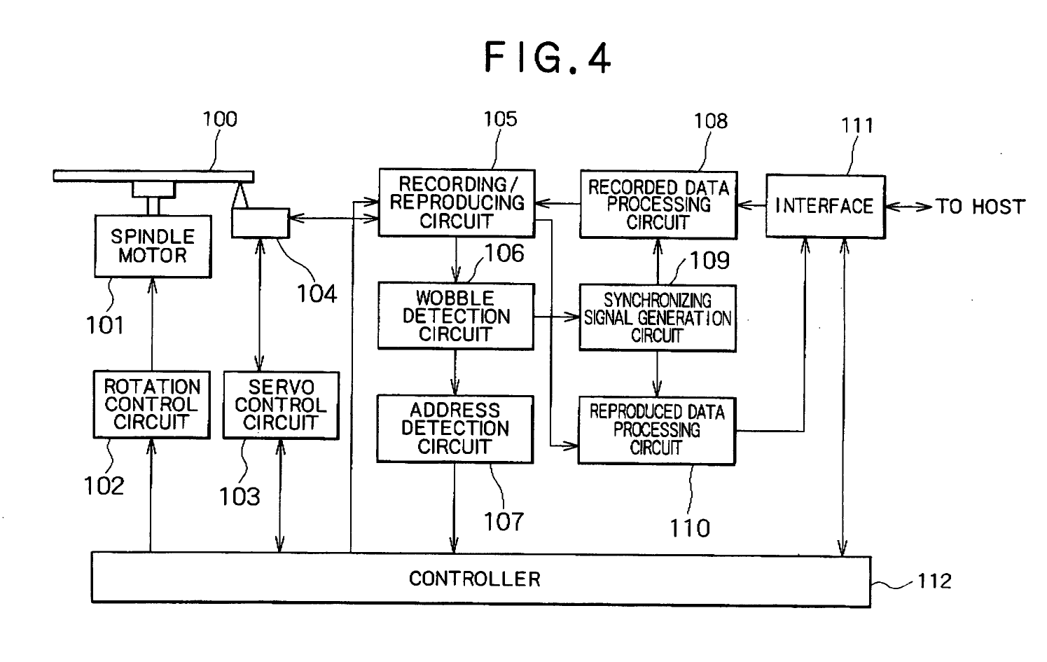

Next, a fifth embodiment of the present invention is described. This is one embodiment of an optical information recording/reproducing apparatus (hereinafter also referred to simply as “recording/reproducing apparatus”) for recording and reproducing information to and from the optical recording media according to the first to fourth embodiments described above. FIG. 4 is a block diagram illustrating the optical information recording/reproducing apparatus according to the present embodiment. As shown in FIG. 4, the recording/reproducing apparatus according to the present embodiment includes a spindle motor 101 for supporting and rotating a disk 100, which is the optical recording medium, and a rotation control circuit 102 for controlling the rotation of this spindle motor 101. The disk 100 is one of the optical recording media according to the first to fourth embodiments.

This recording/reproducing apparatus also includes an optical head 104, which includes a laser source (not shown) for irradiating a blue-violet semiconductor laser beam having a wavelength of, for example, 380 to 430 nm to the disk 100 as the recording laser beam and the reproducing laser beam, and a photodetector (not shown) for detecting feedback light from the disk 100. The apparatus further includes a servo control circuit 103 for controlling the position, focusing, and tracking of the optical head 104.

The apparatus further includes a recording/reproducing circuit 105, which, when recording, drives the laser source inside the optical head 104 to focus the recording laser beam to a predetermined position on the rotating optical disk 100 to record information, and which, when reproducing, causes the laser source inside the optical head 104 to output the reproducing laser beam and causes the photodetector inside the optical head 104 to detect feedback light from the disk 100, to reproduce the recorded information based on the detection results. The recording/reproducing circuit 105 generates a reproduced data signal in accordance with the information recorded on the disk 100, as well as other signals such as a wobble signal indicative of the irradiated position on the disk, a focus servo error signal indicating a focus error, a tracking servo error signal indicating a tracking error, and the like, based on the output signal from the photodetector.

The apparatus further includes a wobble detection circuit 106 for detecting a wobble signal from the signal output from the recording/reproducing circuit 105, and an address detection circuit 107 that detects address information indicating the focus position of the laser beam on the optical disk 100 by demodulating and decoding the output signal from the wobble detection circuit 106. The apparatus further includes a synchronizing signal generation circuit 109 for generating a synchronizing signal in accordance with the output signal from the wobble detection circuit 106, and a reproduced data processing circuit 110 that demodulates the reproduced data signal output from the recording/reproducing circuit 105 based on the synchronizing signal from the synchronizing signal generation circuit 109 and corrects the error in the reproduced data signal to generate reproduced data.

Furthermore, an interface 111 is provided, which performs the following functions: Output reproduced data that is input from the reproduced data processing circuit 110 to an outside host computer (not shown); output recorded data that is input from the host computer to a recorded data processing circuit 108; and output recording/reproducing instruction data that is input from the host computer to a controller 112 that will be described later.

Furthermore, a recorded data processing circuit 108 is provided, which receives recorded data from the interface 111, adds an error correction code to the recorded data, converts data into a format suitable for the recording, and modulates and outputs the data to the recording/reproducing circuit 105. Furthermore, a controller 112 is provided, to which the recording/reproducing instruction data is input from the interface 111, address information is input from the address detection circuit 107, and a feedback signal is input from the servo control circuit 103, and which controls the rotation control circuit 102, the servo control circuit 103, and the recording/reproducing circuit 105.

Next, a description will be given with reference to FIG. 4 on the operation of the recording/reproducing apparatus according to the present embodiment structured as described above. First, the operation when information is recorded on the disk 100 will be described. Recording instruction data and data to be recorded are first input from the host computer to the interface 111. The interface 111 outputs the recording instruction data to the controller 112, and outputs the data to be recorded to the recorded data processing circuit 108. The controller 112 outputs a control signal to the rotation control circuit 102, which in turn drives the spindle motor 101 to rotate the disk 100.

Meanwhile, the recorded data processing circuit 108 adds an error correction code to the data to be recorded input from the interface 111, converts data into a format suitable for the recording, modulates the data, and outputs the data to the recording/reproducing circuit 105. The recording/reproducing circuit 105 drives the laser source inside the optical head 104 in accordance with the data to be recorded, to focus the recording laser beam from the laser source to a predetermined position on the rotating optical disk 100. The recording laser beam is a blue-violet semiconductor laser beam having a wavelength of, for example, 380 to 430 nm. Thereby, marks are formed in the recording layer of the optical disk 100 by the principle described in the section of the first embodiment above, and thus information is recorded.

At the same time, the photodetector in the optical head 104 outputs a detection signal to the recording/reproducing circuit 105, which, based on this signal, generates a wobble signal, a focus servo error signal, and a tracking servo error signal, and outputs these signals to the wobble detection circuit 106. The wobble detection circuit 106 detects the wobble signal from the signal output from the recording/reproducing circuit 105, outputs the wobble signal together with the focus servo error signal and the tracking servo error signal to the address detection circuit 107, and outputs the wobble signal to the synchronizing signal generation circuit 109.

The address detection circuit 107 demodulates and decodes the signal output from the wobble detection circuit 106 so as to detect address information indicative of the focus position of the light beam on the optical disk 100, and outputs the information to the controller 112 with the focus servo error signal and tracking servo error signal. The controller 112 controls the servo control circuit 103 based on the address information, the focus servo error signal, and the tracking servo error signal, and the servo control circuit 103 controls the position, focusing, and tracking of the optical head 104. At the same time, the servo control circuit 103 outputs a feedback signal to the controller 112. The synchronizing signal generation circuit 109 generates and outputs a synchronizing signal to the recorded data processing circuit 108.

Next, the operation when the information recorded on the disk 100 is reproduced will be described. First, the host computer inputs a reproduction instruction data to the interface 111. The interface 111 outputs this reproduction instruction data to the controller 112. The controller 112 outputs a control signal to the rotation control circuit 102, which in turn drives the spindle motor 101 to rotate the disk 100. The controller 112 also outputs a control signal to the recording/reproducing circuit 105, which in turn drives the optical head 104 to output a reproducing laser beam from the laser source in the optical head 104 to the disk 100, and the photodetector in the optical head 104 detects feedback light from the disk 100. The reproducing laser beam is a blue-violet semiconductor laser beam having a wavelength of, for example, 380 to 430 nm. Thereby, information recorded on the disk 100 is read out by the principle described in the section of the first embodiment above.

An output signal from the photodetector of the optical head 104 is input to the recording/reproducing circuit 105, which, based on this output signal, then generates a reproduced data signal, a wobble signal, a focus servo error signal, and a tracking servo error signal, outputs the reproduced data signal to the reproduced data processing circuit 110, and outputs the wobble signal, the focus servo error signal, and the tracking servo error signal to the wobble detection circuit 106. The wobble detection circuit 106 outputs the wobble signal to the synchronizing signal generation circuit 109, which, based on the wobble signal, generates a synchronizing signal and outputs it to the reproduced data processing circuit 110. The reproduced data processing circuit 110 demodulates the reproduced data signal based on the synchronizing signal, and corrects errors in the reproduced data signal to generate reproduced data, which is then output to the interface 111. The interface 111 outputs this reproduced data to the outside host computer. Thereby, information recorded on the disk 100 is reproduced. At the same time, the servo control circuit 103 controls the position, focusing, and tracking of the optical head 104 in the same manner as in the information recording described in the foregoing.

The optical information recording/reproducing apparatus according to the present embodiment can record information to any of the optical recording media described above according to the first to fourth embodiments, and reproduce this information. This enables the use of a blue-violet semiconductor laser beam as the recording and the reproducing laser beam, whereby the recording density of the optical recording medium can be improved.

### EXAMPLE 1

Specific examples of the present invention will be described below. First, with the methods described in the sections of the first and second embodiments above, optical disk media (optical information recording media) to be evaluated were produced. Two types of optical disk media were produced, one being an optical disk medium to which a laser beam is made incident from the side of the transparent resin substrate as described in the first embodiment above (hereinafter referred to as “substrate-side incident type medium”), and the other being an optical disk medium to which a laser beam is made incident from the side of the cover layer (PC film) as described in the second embodiment above (hereinafter referred to as “cover layer-side incident type medium”). That is, each layer was sequentially formed on a transparent resin substrate pre-formed with guide grooves or pre-pits, using an inline sputtering machine. The layer structure of each medium is as follows. In the following description, the structure wherein “A layer,” “B layer,” and “C layer” are formed sequentially from the side of the substrate will be represented as A/B/C. The layer structure of the substrate-side incident type medium was PC substrate/first dielectric layer/recording layer/second dielectric layer/AlTi reflective layer/UV adhesive layer/dummy PC substrate. The layer structure of the cover layer-side incident type medium was PC Substrate/AlTi reflective layer/first dielectric layer/recording layer/second dielectric layer/UV adhesive layer/PC cover layer.

The recording layer was deposited by co-sputtering using two sputtering targets, one being an alloy target of a predetermined composition, and the other being a dielectric target. The compositions of the matrix and fine crystal grains of the recording layer were different in each of the media. Power was applied independently for each target, each being adjusted during the film deposition so that the fine crystal grains of alloy were uniformly dispersed in the dielectric matrix. The substrate was arranged parallel and opposite each target, and revolved at a rotation speed of 40 rpm. The transparent resin substrate passes above the alloy target and the dielectric target alternately by this revolving motion, whereby the fine crystal grains were made to disperse uniformly in the recording layer. A ZnS—SiO₂ film was formed as the dielectric layer, and an AlTi film was formed as the reflective layer 5.

The recording/reproducing characteristics of the optical disk medium produced as described above were evaluated. The evaluation included the following: Using the optical information recording/reproducing apparatus of the fifth embodiment (see FIG. 4) described above, a signal with a period of 8T was recorded with a recording power with which noise is minimal, and the reproducing signal quality and the reproducing light resistance of this signal were evaluated. The evaluation of the reproducing signal quality was done by reproducing the above mentioned 8T signal and measuring its C/N ratio (carrier to noise ratio). If the C/N ratio is 53 dB or more, it is determined that the reproducing signal has good quality. The evaluation of the reproducing light resistance was done by reproducing the same track 100,000 times with a power larger than the reproducing power by 0.2 mW (see Table 1) and measuring a difference from the initial value of C/N ratio of 8T signal. Some of the optical disk media were picked up to observe the recorded portions and non-recorded portions in the recording layer with a TEM (transmission electronic microscope) and to measure the particle diameter of the fine crystal grains. Table 1 shows the measurement conditions. Table 2 shows the compositions of the fine crystal grains and matrix of the recording layer, recording power, reproducing signal quality (C/N ratio of 8T signal), and reproducing light resistance (difference in the C/N ratio of 8T signal). In Table 2, “Ag₉₈Pd₁Cu₁”, for example, represents an Ag—Pd—Cu alloy having a composition of 98 mass % of Ag, 1 mass % of Pd, and 1 mass % of Cu. This presentation rule also applies to other examples in the following. Also, “substrate” in the column “layer structure” represents the substrate-side incident type medium, and “cover” represents the cover layer-side incident type medium.

TABLE 1

| | Substrate-side | Cover layer-side |
|---|---|---|
| | incident type | incident type |
| Medium type | medium | medium |
| Laser beam | 405 nm | 405 nm |
| wavelength (λ) | | |
| Numerical aperture | 0.65 | 0.85 |
| of lens (NA) | | |
| Linear speed (m/sec) | 5.6 | 5.1 |
| Recording frequency | 55 MHz | 66 MHz |
| Recording power | 6-12 mW | 3-7.5 mW |
| Reproducing power | 0.5 mW | 0.4 mW |

TABLE 2

| | | | | | | Re- |
|---|---|---|---|---|---|---|
| | | Recording layer | | Re- | | producing |
| Exam- | | Fine | | cording | 8T | light |
| ple | Layer | crystal | | power | C/N | resistance |
| No. | structure | grains | Matrix | (mW) | (dB) | (dB) |
| 1 | Substrate | Ag₉₈Pd₁Cu₁ | SiO₂ | 10.5 | 56.3 | 0 |
| 2 | Substrate | Ag₉₈Pd₁Cu₁ | Al₂O₃ | 10.3 | 55.8 | 0 |
| 3 | Substrate | Ag₉₈Pd₁Cu₁ | Ta₂O₅ | 10.8 | 55.6 | 0 |
| 4 | Substrate | Ag₉₈Pd₁Cu₁ | SiN | 10.7 | 56.2 | 0 |
| 5 | Substrate | Ag₉₈Pd₁Cu₁ | AlN | 10.9 | 55.7 | 0 |
| 6 | Substrate | Ag₉₈Pd₁Cu₁ | TaN | 10.6 | 55.9 | 0 |
| 7 | Cover | Ag₉₈Pd₁Cu₁ | SiO₂ | 6.3 | 55.8 | 0 |
| 8 | Cover | Ag₉₈Pd₁Cu₁ | Al₂O₃ | 6.2 | 55.4 | 0 |
| 9 | Cover | Ag₉₈Pd₁Cu₁ | Ta₂O₅ | 6.6 | 55.6 | 0 |
| 10 | Cover | Ag₉₈Pd₁Cu₁ | SiN | 6.5 | 55.7 | 0 |
| 11 | Cover | Ag₉₈Pd₁Cu₁ | AlN | 6.6 | 54.8 | 0 |
| 12 | Cover | Ag₉₈Pd₁Cu₁ | TaN | 6.4 | 55.2 | 0 |

In the optical disk media of No. 1 and No. 7 shown in Table 2, the particle diameter of the fine crystal grains of the recording layer was about 3 to 7 nm in the non-recorded portions, and 30 to 80 nm in the recorded portions. This indicates that laser irradiation has increased the particle diameter of the fine crystal grains.

As shown in Table 2, the optical information recording media with a recording layer that is formed by co-sputtering from the fine crystal grains of Ag₉₈Pd₁Cu₁ (mass %) alloy and the matrix of an oxide dielectric or a nitride dielectric exhibited a high reproducing C/N ratio and good reproducing light resistance.

### EXAMPLE 2

Optical disk media having fine crystal grains formed of Ag—Te alloy were produced with the same method as Example 1 described above, and their characteristics were evaluated. The optical disk media had two layer structures, one being the substrate-side incident type medium as with the above described first embodiment and the other being the cover layer-side incident type medium as with the above described second embodiment. Table 3 shows the compositions of the fine crystal grains and matrix of the recording layer, recording power, reproducing signal quality (C/N ratio of 8T signal), and reproducing light resistance (difference in the C/N ratio of 8T signal). The production method of the optical disk media, evaluation method, and presentation rule of Table 3 are the same as those of the above described Example 1. The composition, 51% Ag and 49% Te in mass percent, is equal to 55% Ag and 45% Te in atomic percent.

TABLE 3

| | | Recording layer | | Re- | | Reproducing |
|---|---|---|---|---|---|---|
| Exam- | | Fine | | cording | 8T | light |
| ple | Layer | crystal | | power | C/N | resistance |
| No. | structure | grains | Matrix | (mW) | (dB) | (dB) |
| 13 | Substrate | Ag₅₁Te₄₉ | SiO₂ | 9.5 | 56.2 | 0 |
| 14 | Substrate | Ag₅₁Te₄₉ | Al₂O₃ | 9.9 | 56.2 | 0 |
| 15 | Substrate | Ag₅₁Te₄₉ | Ta₂O₅ | 9.1 | 56.4 | 0 |
| 16 | Substrate | Ag₅₁Te₄₉ | SiN | 9.6 | 55.8 | 0 |
| 17 | Substrate | Ag₅₁Te₄₉ | AlN | 9.7 | 55.3 | 0 |
| 18 | Substrate | Ag₅₁Te₄₉ | TaN | 9.7 | 55.9 | 0 |
| 19 | Cover | Ag₅₁Te₄₉ | SiO₂ | 5.2 | 55.9 | 0 |
| 20 | Cover | Ag₅₁Te₄₉ | Al₂O₃ | 5.8 | 56.1 | 0 |
| 21 | Cover | Ag₅₁Te₄₉ | Ta₂O₅ | 5.7 | 55.7 | 0 |
| 22 | Cover | Ag₅₁Te₄₉ | SiN | 5.3 | 55.1 | 0 |
| 23 | Cover | Ag₅₁Te₄₉ | AlN | 5.5 | 55.7 | 0 |
| 24 | Cover | Ag₅₁Te₄₉ | TaN | 5.2 | 55.2 | 0 |

In the optical disk media of No. 16 and No. 22 shown in Table 3, the particle diameter of the fine crystal grains of the recording layer was about 3 to 7 nm in the non-recorded portions, and 30 to 80 nm in the recorded portions. This indicates that laser irradiation has increased the particle diameter of the fine crystal grains.

As shown in Table 3, the optical information recording media with a recording layer that is formed by co-sputtering from the fine crystal grains of Ag₅₁Te₄₉ (mass %) alloy and the matrix of an oxide dielectric or a nitride dielectric exhibited a high reproducing C/N ratio and good reproducing light resistance. Also, the optical disk media with a recording layer formed from the fine crystal grains of Ag₆₁Te₃₉ (mass %) or Ag₄₆Te₅₄ (mass %) alloy and the matrix of an oxide dielectric or a nitride dielectric shown in Table 3 exhibited the same results as the reproducing characteristics shown in Table 3.

### EXAMPLE 3

Optical disk media having fine crystal grains formed of Cu—In alloy were produced with the same method as Example 1 described above, and their characteristics were evaluated. The optical disk media had two layer structures, one being the substrate-side incident type medium as with the above described first embodiment and the other being the cover layer-side incident type medium as with the above described second embodiment. Table 4 shows the compositions of the fine crystal grains and matrix of the recording layer, recording power, reproducing signal quality (C/N ratio of 8T signal), and reproducing light resistance (difference in the C/N ratio of 8T signal). The production method of the optical disk media, evaluation method, and presentation rule of Table 4 are the same as those of the above described Example 1.

TABLE 4

| | | Recording layer | | Re- | | Reproducing |
|---|---|---|---|---|---|---|
| Exam- | | Fine | | cording | 8T | light |
| ple | Layer | crystal | | power | C/N | resistance |
| No. | structure | grains | Matrix | (mW) | (dB) | (dB) |
| 25 | Substrate | Cu₅₀In₅₀ | SiO₂ | 9.3 | 56.4 | 0 |
| 26 | Substrate | Cu₅₀In₅₀ | Al₂O₃ | 9.3 | 55.9 | 0 |
| 27 | Substrate | Cu₅₀In₅₀ | Ta₂O₅ | 9.6 | 55.6 | 0 |
| 28 | Substrate | Cu₅₀In₅₀ | SiN | 9.7 | 56.2 | 0 |
| 29 | Substrate | Cu₅₀In₅₀ | AlN | 9.1 | 55.8 | 0 |
| 30 | Substrate | Cu₅₀In₅₀ | TaN | 9.5 | 55.2 | 0 |
| 31 | Cover | Cu₅₀In₅₀ | SiO₂ | 5.3 | 56.4 | 0 |
| 32 | Cover | Cu₅₀In₅₀ | Al₂O₃ | 5.1 | 56.1 | 0 |
| 33 | Cover | Cu₅₀In₅₀ | Ta₂O₅ | 5.7 | 55.2 | 0 |
| 34 | Cover | Cu₅₀In₅₀ | SiN | 5.5 | 55.7 | 0 |
| 35 | Cover | Cu₅₀In₅₀ | AlN | 5.4 | 55.8 | 0 |
| 36 | Cover | Cu₅₀In₅₀ | TaN | 5.7 | 55.1 | 0 |

In the optical disk media of No. 26 and No. 32 shown in Table 4, the particle diameter of the fine crystal grains of the recording layer was about 3 to 7 nm in the non-recorded portions, and 30 to 80 nm in the recorded portions. This indicates that laser irradiation has increased the particle diameter of the fine crystal grains.

As shown in Table 4, the optical information recording media with a recording layer that is formed by co-sputtering from the fine crystal grains of Cu₅₀In₅₀ (mass %) alloy and the matrix of an oxide dielectric or a nitride dielectric exhibited a high reproducing C/N ratio and good reproducing light resistance. Also, the optical disk media with a recording layer formed from the fine crystal grains of Cu₆₀In₄₀ (mass %) or Cu₅In₉₅ (mass %) alloy and the matrix of an oxide dielectric or a nitride dielectric shown in Table 3 exhibited the same results as the reproducing characteristics shown in Table 4.

The recording laser beam and the reproducing laser beam used in the above described Examples 1 to 3 had a wavelength of 405 nm, but it was confirmed that the same effects and results are achieved if the laser beam has a wavelength in a range of 380 to 430 nm. In the above described Examples 1 to 3, when the laser beam had a wavelength of less than 380 nm, the laser light absorption in the PC substrate increased drastically, resulting in unfavorable recording performance or reproducing performance. On the other hand, when the laser beam had a wavelength of 440 nm or more, the absorption rate in the recording layer started to decrease, because of which a higher recording power was necessary at the time of recording, and high-speed recording of information became difficult. Accordingly, the laser beam used for the recording and reproduction of information should preferably have a wavelength in a range of 380 to 430 nm.

### EXAMPLE 4

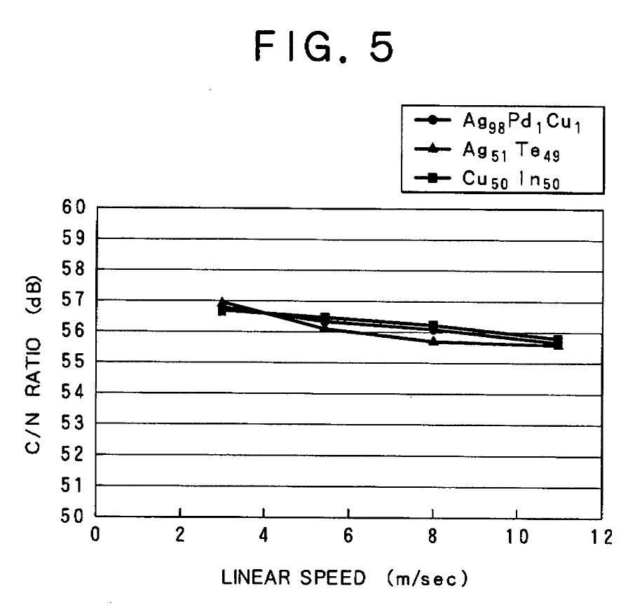

Next, the influence of linear speed on the reproducing characteristics was investigated. FIG. 5 is a graph showing the influence of linear speed on the quality of reproducing signal, the horizontal axis representing the linear speed of the optical disk medium during recording and reproduction and the vertical axis representing the C/N ratio of 8T signal. In this fourth example, a substrate-side incident type medium shown in the above described first embodiment was used as the optical disk medium, its recording layer being formed by co-sputtering, with the matrix made of SiO₂ and the fine crystal grains made of one of an Ag₉₈Pd₁Cu₁ alloy, Ag₅₁Te₄₉ alloy, and Cu₅₀In₅₀ alloy. With this optical disk medium, the linear speed was changed in the range of from 3.0 to 11.0 m/sec, while a signal with a period of 8T was recorded and reproduced, and the C/N ratio for each linear speed was measured. The production method of the optical disk media and measurement method other than the above are the same as those of the above described Example 1. The measurement results are shown in FIG. 5. As shown in FIG. 5, the above optical recording medium exhibited good C/N ratio values in the above linear speed range, which indicates that it is applicable to high-speed recording.

Also, the optical disk media with a recording layer formed by co-sputtering using the alloys with the compositions shown in the first to third examples for the fine crystal grains and the above mentioned dielectrics exhibited the same results as those shown in FIG. 5.

While, in the above first to fourth examples, as described above, the recording layer was formed by co-sputtering using an alloy target and a dielectric target, these alloy and dielectrics may be sintered or fused together into one target, and the recording layer may be formed by sputtering using this target. In this case, too, the results were the same as those shown in FIG. 5.

### EXAMPLE 5

Next, the reproducing characteristics of optical disk media having a double-layer recording layer were evaluated. The optical disk media had two layer structures, one being the substrate-side incident type medium as with the above described third embodiment and the other being the cover layer-side incident type medium as with the above described fourth embodiment. That is, the layer structure of the substrate-side incident type medium was PC substrate/dielectric layer/first recording layer/dielectric layer/optical separation layer/dielectric layer/second recording layer/dielectric layer/reflective layer/UV adhesive layer/dummy PC substrate. The layer structure of the cover layer-side incident type medium was PC substrate/reflective layer/dielectric layer/second recording layer/dielectric layer/optical separation layer/dielectric layer/first recording layer/dielectric layer/UV adhesive layer/PC cover layer. The fine crystal grains of the recording layer were made of one of an Ag₉₈Pd₁Cu₁ alloy, Ag₅₁Te₄₉ alloy, and Cu₅₀In₅₀ alloy, and the matrix was made of SiO₂. The first recording layer had a thickness of 7 nm, and the second recording layer 12 nm. The structure and production method of these optical disk media other than the above are the same as the above described Example 1.

The reproducing characteristics of the optical disk media thus produced were evaluated. The evaluation method was the same as that of the above described Example 1. Table 5 shows the reproducing characteristics of the first recording layer, i.e., compositions of the fine crystal grains and matrix of the first recording layer, recording power, reproducing signal quality (C/N ratio of 8T signal), and reproducing light resistance (difference in the C/N ratio of 8T signal). Table 6 shows the reproducing characteristics of the second recording layer, i.e., compositions of the fine crystal grains and matrix of the second recording layer, recording power, reproducing signal quality (C/N ratio of 8T signal), and reproducing light resistance (difference in the C/N ratio of ST signal).

TABLE 5

| | | | | | | Re- |
|---|---|---|---|---|---|---|
| | | Recording layer | | Re- | | producing |
| Exam- | | Fine | | cording | 8T | light |
| ple | Layer | crystal | | power | C/N | resistance |
| No. | structure | grains | Matrix | (mW) | (dB) | (dB) |
| 37 | Substrate | Ag₉₈Pd₁Cu₁ | SiO₂ | 9.1 | 56.1 | 0 |
| 38 | Substrate | Ag₅₁Te₄₉ | SiO₂ | 10.2 | 55.7 | 0 |
| 39 | Substrate | Cu₅₀In₅₀ | SiO₂ | 9.4 | 56.0 | 0 |
| 40 | Cover | Ag₉₈Pd₁Cu₁ | SiO₂ | 5.3 | 55.6 | 0 |
| 41 | Cover | Ag₅₁Te₄₉ | SiO₂ | 5.5 | 56.2 | 0 |
| 42 | Cover | Cu₅₀In₅₀ | SiO₂ | 5.9 | 55.3 | 0 |

TABLE 6

| | | | | | | Re- |
|---|---|---|---|---|---|---|
| | | Recording layer | | Re- | | producing |
| Exam- | | Fine | | cording | 8T | light |
| ple | Layer | crystal | | power | C/N | resistance |
| No. | structure | grains | Matrix | (mW) | (dB) | (dB) |
| 43 | Substrate | Ag₉₈Pd₁Cu₁ | SiO₂ | 9.9 | 55.6 | 0 |
| 44 | Substrate | Ag₅₁Te₄₉ | SiO₂ | 10.7 | 55.8 | 0 |
| 45 | Substrate | Cu₅₀In₅₀ | SiO₂ | 10.2 | 55.4 | 0 |
| 46 | Cover | Ag₉₈Pd₁Cu₁ | SiO₂ | 5.8 | 55.1 | 0 |
| 47 | Cover | Ag₅₁Te₄₉ | SiO₂ | 6.1 | 55.7 | 0 |
| 48 | Cover | Cu₅₀In₅₀ | SiO₂ | 6.3 | 55.1 | 0 |

Table 5 and Table 6 indicate that, in the double-layer recording media having a recording layer separated by an optical separation layer, the reproducing C/N ratio of the first and second recording layers is equally high as that of the recording media having a single-layer recording layer, and that the reproducing light resistance is satisfactorily acceptable for actual use.

### INDUSTRIAL APPLICABILITY

The present invention is suitably applicable to optical information recording media such as CD-R, DVD-R, and the like, which uses irradiation of a blue-violet semiconductor laser beam to record and reproduce information.

1. An optical information recording medium including a substrate and a recording layer formed on the substrate, information being recorded and reproduced by irradiating light to this recording layer, characterized in that the recording layer includes a matrix made of a dielectric and a plurality of fine crystal grains made of a metal or an alloy and dispersed in the matrix, and, by irradiating light to the recording layer, a size of the fine crystal grains is changed in a portion irradiated by the light, whereby information is recorded.

2. The optical information recording medium according to claim 1, characterized in that the fine crystal grains are made of a metal or an alloy of two or more metals selected from the group consisting of Ag, Cu, In, Pd, and Te.

3. The optical information recording medium according to claim 2, characterized in that the fine crystal grains are made of an Ag—Pd—Cu alloy containing 0.3 to 25 mass % of Pd and 0.3 to 25 mass % of Cu, the balance being Ag and unavoidable impurities.

4. The optical information recording medium according to claim 2, characterized in that the fine crystal grains are made of an Ag—Te alloy containing 38 to 55 mass % of Te, the balance being Ag and unavoidable impurities.

5. The optical information recording medium according to claim 2, characterized in that the fine crystal grains are made of a Cu—In alloy containing 40 to 95 mass % of In, the balance being Cu and unavoidable impurities.

6. The optical information recording medium according to claim 1, characterized in that the dielectric is an oxide dielectric.

7. The optical information recording medium according to claim 6, characterized in that the oxide dielectric is one or two or more oxides selected from the group consisting of silicon oxide, aluminum oxide, and tantalum oxide.

8. The optical information recording medium according to claim 1, characterized in that the dielectric is a nitride dielectric.

9. The optical information recording medium according to claim 8, characterized in that the nitride dielectric is one or two or more nitrides selected from the group consisting of silicon nitride, aluminum nitride, and tantalum nitride.

10. The optical information recording medium according to claim 1 characterized by including a first dielectric layer formed between the substrate and the recording layer, a second dielectric layer formed on the recording layer, and a reflective layer formed on the second dielectric layer, the substrate being a transparent substrate, wherein the light is made incident toward the recording layer from the side of the substrate.

11. The optical information recording medium according to claim 1, characterized by including a reflective layer formed between the substrate and the recording layer, a first dielectric layer formed between the reflective layer and the recording layer, a second dielectric layer formed on the recording layer, and a light transmission layer formed on the second dielectric layer, wherein the light is made incident toward the recording layer from the side of the light transmission layer.

12. The optical information recording medium according to claim 1, characterized in that the recording layer consists of a plurality of layers, which are separated from each other by an interlayer optical separation layer.

13. The optical information recording medium according to claim 1, characterized in that the light is a laser beam with a wavelength of 380 to 430 nm.

14. An optical information recording/reproducing apparatus characterized in that light is irradiated to the optical information recording medium according to claim 1 to change the size of the fine crystal grains. In the light-irradiated portion of the recording layer so as to change the reflectance in the portion to record information, and the information is reproduced by detecting a difference in the reflectance of the recording layer.
